(19) United States
(12) Patent Application Publication
(10) Pub. No.: US 2021/0370752 A1
(43) Pub. Date: Dec. 2, 2021

(54) Impact Resistant Vehicle Cover Assembly

(71) Applicant: Stanley Johnson, Corona, CA (US)

(72) Inventor: Stanley Johnson, Corona, CA (US)

(21) Appl. No.: 16/890,012

(22) Filed: Jun. 2, 2020

(51) Int. Cl. B60J 11/04; B32B 3/18; B32B 3/30

(52) U.S. Cl. CPC B60J 11/04; B32B 3/18; B32B 2571/00; B32B 2307/558; B32B 3/30

(57) ABSTRACT

An impact resistant vehicle cover assembly includes a first sheet that is positionable over a vehicle. The first sheet is comprised of a synthetic textile such that the first sheet is inhibited from abrading the vehicle. A second sheet is positioned on the first sheet and the second sheet is comprised of a resiliently compressible material to protect the vehicle from impact damage. A plurality of domes is each coupled to the second sheet and each of the domes is comprised of a resiliently compressible material to protect the vehicle from impact damage. A third sheet is positioned over the domes and the third sheet is comprised of a resiliently compressible material to resist being damaged by projectiles.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vehicle cover device and more particularly pertains to a new vehicle cover device for protecting a vehicle from hail and precipitation.

### (2) Description of Related Art Including Information Disclosed Under 37 CFR 1.97 and 1.98

The prior art relates to vehicle cover devices including a car cover that includes a plurality of layers and air bubbles positioned between the layers. The prior art discloses a variety of vehicle covers that each comprises a plurality of cushions that are coupled together for protecting a vehicle from impact damage. The prior art also discloses a variety of vehicle covers that are inflatable for protecting a vehicle from hail damage. The prior art further discloses a vehicle cover with pockets integrated therein for receiving cushions to protect a vehicle from hail damage.

### BRIEF SUMMARY OF THE INVENTION

An embodiment of the disclosure meets the needs presented above by generally comprising a first sheet that is positionable over a vehicle. The first sheet is comprised of a synthetic textile such that the first sheet is inhibited from abrading the vehicle. A second sheet is positioned on the first sheet and the second sheet is comprised of a resiliently compressible material to protect the vehicle from impact damage. A plurality of domes is each coupled to the second sheet and each of the domes is comprised of a resiliently compressible material to protect the vehicle from impact damage. A third sheet is positioned over the domes and the third sheet is comprised of a resiliently compressible material to resist being damaged by projectiles.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective in-use view of an impact resistant vehicle cover assembly according to an embodiment of the disclosure.

FIG. 2 is a cut-away view taken from circle 2 of FIG. 1 of an embodiment of the disclosure.

FIG. 3 is a bottom view of an embodiment of the disclosure.

FIG. 4 is a left side phantom perspective view of an embodiment of the disclosure.

### DETAILED DESCRIPTION OF THE INVENTION

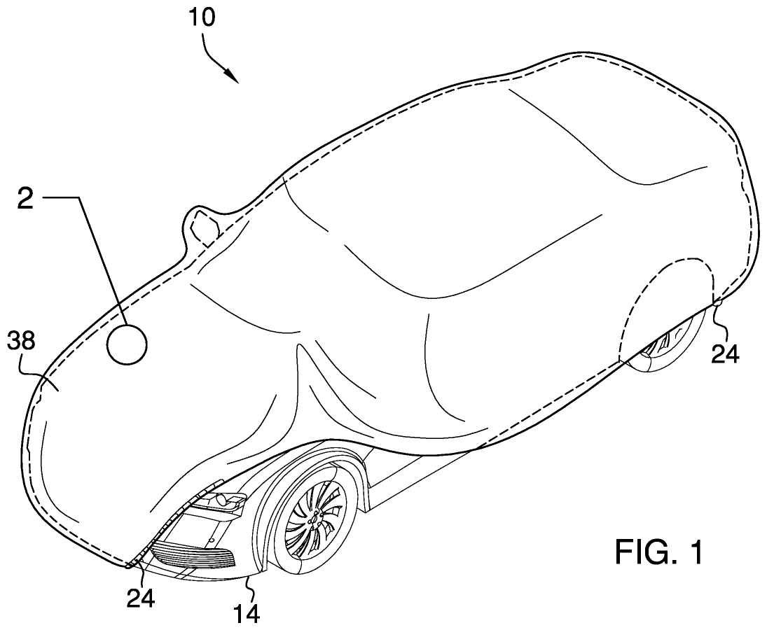

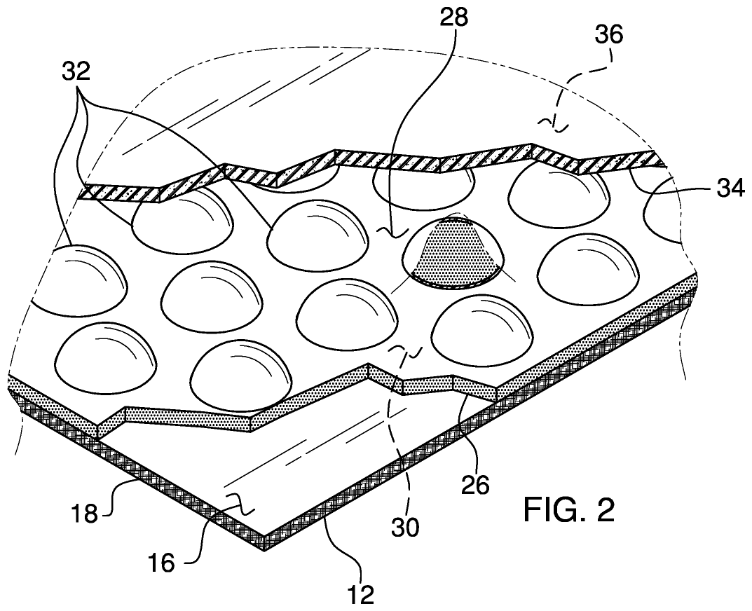

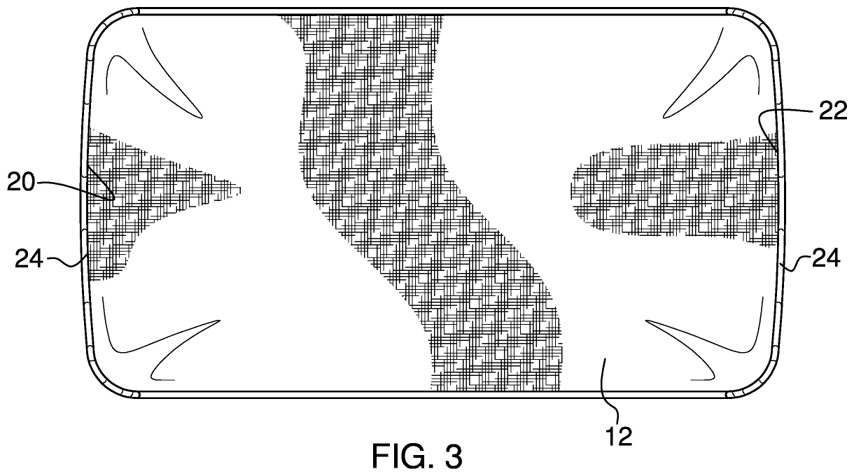

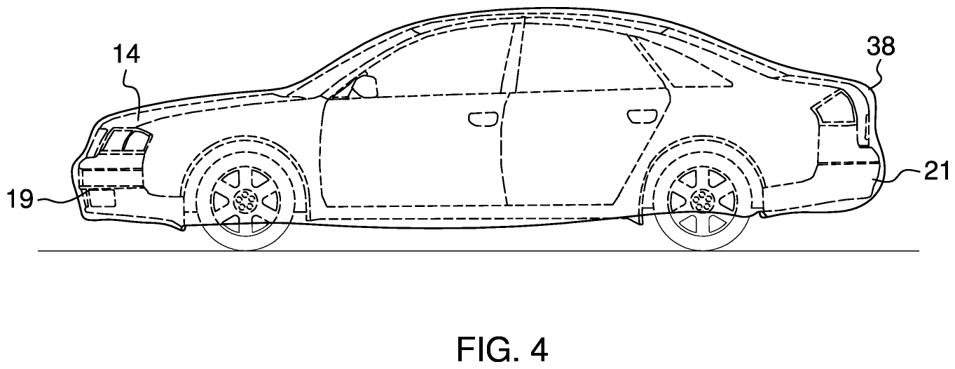

With reference now to the drawings, and in particular to FIGS. 1 through 4 thereof, a new vehicle cover device embodying the principles and concepts of an embodiment of the disclosure and generally designated by the reference numeral 10 will be described.

As best illustrated in FIGS. 1 through 4, the impact resistant vehicle cover assembly 10 generally comprises a first sheet 12 that is positionable over a vehicle 14. The vehicle 14 may be a passenger vehicle, such as a car, a cargo vehicle such as a pickup, or any other vehicle that has body panels that can be deformed from impact energy. The first sheet 12 is comprised of a synthetic textile such that the first sheet 12 is inhibited from abrading the vehicle 14. The first sheet 12 has a top surface 16 and a perimeter edge 18, and the perimeter edge 18 has a front side 20 and a back side 22.

A pair of elastomeric members 24 is each coupled to a respective one of the front side 20 and the back side 22 of the perimeter edge 18 of the first sheet 12. Each of the elastomeric members 24 tightens the front side 20 and the back side 22 beneath a respective front side 19 and back side 21 of the vehicle 14 for retaining the first sheet 12 on the vehicle 14. A second sheet 26 is provided and the second sheet 26 is positioned on the first sheet 12. The second sheet 26 is comprised of a resiliently compressible material to protect the vehicle 14 from impact damage. The second sheet 26 has an upper surface 28 and a lower surface 30. the lower surface 30 is bonded to the top surface 16 of the first sheet 12.

A plurality of domes 32 is provided and each of the domes 32 is coupled to the second sheet 26. Each of the domes 32 is comprised of a resiliently compressible material to absorb impact energy for protecting the vehicle 14 from impact damage. The domes 32 are spaced apart from each other and are distributed over an entirety of the upper surface 28 of the first sheet 12. Each of the domes 32 may be comprised of a compressible gel, foam rubber or other similar material.

A third sheet 34 is provided and the third sheet 34 is positioned over the domes 32. The third sheet 34 is comprised of a resiliently compressible material to resist being damaged by projectiles. Additionally, the third sheet 34 is comprised of a fluid impermeable material to protect the vehicle 14 from precipitation. The third sheet 34 has a bottom surface 36 and the bottom surface 36 is bonded to an apex of each of the domes 32. The first sheet 12, the second sheet 26, the domes 32 and the third sheet 34 define a cover 38 that is positionable over the vehicle 14 to protect to the vehicle 14 from sunlight, precipitation and hail.

In use, the cover 38 is positioned over the vehicle 14 and each of the elastomeric members 24 is stretched beneath the respective front side 20 and back side 22 of the perimeter edge 18 of the first sheet 12. In this way the third sheet 34 protects the vehicle 14 from precipitation and the domes 32 protect the vehicle 14 from impact damage. The second layer facilitates an additional degree of impact protection with respect to the domes 32. The cover 38 is removed from the vehicle 14 before driving the vehicle 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An impact resistant vehicle cover assembly for protecting a vehicle's exterior from impact damage, said assembly comprising:
a first sheet being positionable over a vehicle, said first sheet being comprised of a synthetic textile such that said first sheet is inhibited from abrading the vehicle;
a second sheet being positioned on said first sheet, said second sheet being comprised of a resiliently compressible material wherein said second sheet is configured to protect the vehicle from impact damage;
a plurality of domes, each of said domes being coupled to said second sheet, each of said domes being comprised of a resiliently compressible material wherein each of said domes is configured to absorb impact energy to protect the vehicle from impact damage; and
a third sheet being positioned over said domes, said third sheet being comprised of a resiliently compressible material wherein said third sheet is configured to resist being damaged by projectiles.

2. The assembly according to claim 1, wherein:
said first sheet has a top surface and a perimeter edge, said perimeter edge having a front side and a back side; and
said assembly includes a pair of elastomeric members, each of said elastomeric members being coupled to a respective one of said front side and said back side of said perimeter edge of said first sheet, each of said elastomeric members tightening said front side and said back side beneath a respective front side and back side of the vehicle for retaining said first sheet on the vehicle.

3. The assembly according to claim 1, wherein:
said first sheet has a top surface; and
said second sheet has an upper surface and a lower surface, said lower surface being bonded to said top surface of said first sheet; and
said domes being spaced apart from each other and being distributed over an entirety of said upper surface of said first sheet.

4. The assembly according to claim 3, wherein:
said third sheet is comprised of a fluid impermeable material wherein said third sheet is configured to protect the vehicle from precipitation; and
said third sheet has a bottom surface, said bottom surface being bonded to an apex of each of said domes.

5. An impact resistant vehicle cover assembly for protecting a vehicle's exterior from impact damage, said assembly comprising:
a first sheet being positionable over a vehicle, said first sheet being comprised of a synthetic textile such that said first sheet is inhibited from abrading the vehicle, said first sheet having a top surface and a perimeter edge, said perimeter edge having a front side and a back side;
a pair of elastomeric members, each of said elastomeric members being coupled to a respective one of said front side and said back side of said perimeter edge of said first sheet, each of said elastomeric members tightening said front side and said back side beneath a respective front side and back side of the vehicle for retaining said first sheet on the vehicle;
a second sheet being positioned on said first sheet, said second sheet being comprised of a resiliently compressible material wherein said second sheet is configured to protect the vehicle from impact damage, said second sheet having an upper surface and a lower surface, said lower surface being bonded to said top surface of said first sheet;
a plurality of domes, each of said domes being coupled to said second sheet, each of said domes being comprised of a resiliently compressible material wherein each of said domes is configured to absorb impact energy to protect the vehicle from impact damage, said domes being spaced apart from each other and being distributed over an entirety of said upper surface of said first sheet; and
a third sheet being positioned over said domes, said third sheet being comprised of a resiliently compressible material wherein said third sheet is configured to resist being damaged by projectiles, said third sheet being comprised of a fluid impermeable material wherein said third sheet is configured to protect the vehicle from precipitation, said third sheet having a bottom surface, said bottom surface being bonded to an apex of each of said domes.
